(19) United States
(12) Patent Application Publication
(10) Pub. No.: US 2023/0125893 A1
(43) Pub. Date: Apr. 27, 2023

(54) HYBRID MATERIAL PROCESSING METHOD AND SYSTEM

(71) Applicant: National Central University, Taoyuan City (TW)

(72) Inventors: JENG-RONG HO, Taoyuan City (TW); CHIH-KUANG LIN, Taoyuan City (TW); PI-CHENG TUNG, Taoyuan City (TW)

(21) Appl. No.: 17/535,797

(22) Filed: Nov. 26, 2021

(30) Foreign Application Priority Data
Oct. 26, 2021 (TW) 110139692

(51) Int. Cl. B23K 26/00; B23K 26/53; B23K 26/08; B23C 3/28

(52) U.S. Cl. CPC B23K 26/0093; B23K 26/53; B23K 26/0884; B23K 26/0006; B23C 3/28

(57) ABSTRACT

The present invention relates to a hybrid material processing method includes steps of: emitting a laser beam toward an intended-to-be-modified area intended on a workpiece by a laser to perform a property modification for the intended-to-be-modified area; applying an optical image positioning assisted equipment to perform a precise positioning for a modified area or a positioning marker on the workpiece, so as to align a machine tool to the modified area; and driving the machine tool to perform a processing for the modified area.

### CROSS-REFERENCE TO RELATED APPLICATION

This application claims priority benefit to Taiwan Invention Patent Application Serial No. 110139692, filed on Oct. 26, 2021, in Taiwan Intellectual Property Office, the entire disclosures of which are incorporated by reference herein.

### FIELD

The present invention relates to a hybrid material processing method and system, in particular to a hybrid material processing method and system which combines both the contactless laser processing and the mechanical machining technologies.

### BACKGROUND

In the state of the art, there are several processing techniques available for processing hard-brittle materials, including a process called electrochemical machining (ECM), which basically includes the following steps of immersing a workpiece in an electrolyte solution to serve as an anode, applying a potential difference between the anode and a cathode; and then removing a part of material through the electrochemical corrosion effect evoked by the electrolysis process, whereby to process the workpiece. ECM is usually for processing of superhard or ultrahard materials. However, if ECM is used to drill and process the workpieces made of hard-brittle materials, there will be problems such as longer processing time, and the taper angle will be not easy to be made as required. This is because the ECM process adjusts the energy of the electrons on the surface of the anode by adjusting electric potential, which creates electron transfer between electro-activated materials and the anode. Therefore, ECM is more suitable for conductive materials, and is not applicable for purposes such as processing highly insulated hard-brittle materials.

An electrical discharge machining (EDM) is a noncontact process for processing materials, and it generates sparks by electric discharge to make workpieces form predetermined shapes. The electrode of a workpiece and the electrode of the tool are separated by dielectric substances. By applying a current that changes periodically and rapidly between the electrodes of the workpiece and the tool, sparks can be created on the electrodes. However, if the EDM is used for drilling, since this technique uses sparks generated by electric discharge to process workpieces, this process is only applicable for conductive materials, and, thus, it is not suitable to process highly insulated hard-brittle materials.

Another process called laser drilling uses an optical lens system to guide and focus a laser beam, pointing the laser beam at the portions that need to be processed. The materials at the processing portions will be melted or vaporized, and therefore the laser drilling process is particularly suitable for drilling micro-holes. However, while applying the laser drilling process to drill a workpiece, due to the sudden temperature rise on the surface of the material caused by projecting a laser beam thereon, the workpiece will be melted or vaporized after absorbing the laser and then having its temperature increased rapidly. As a result, the process tends to produce unwanted dross, debris or condensed evaporates, and the taper angle will be not easy to be made as required.

In the field of processing transparent materials, a process called laser filament machining, that uses an ultrafast laser to create a nonlinear absorption phenomenon and forms a filament-like property modification zone inside a workpiece, is also often used. The incident laser beam will have self-focusing and defocusing effects along the formed filament. It takes the advantages of rapid processing along the filament and being capable of forming a high-aspect-ratio structure, the processing parameters for filament machining are, however, not easy to control.

As for mechanical machining, it is a contact processing technique that uses a machine tool to cut, engrave, or mill workpieces at room temperature. The shapes, sizes, or properties of workpieces can be changed by removing materials. However, suppose the mechanical machining process is applied to drill micro-holes on hard-brittle materials, the great stress produced during the processing procedure will be likely to damage the workpiece. Furthermore, the processing chips are not easy to remove, and the machine tool tends to wear.

Therefore, when it comes to drill transparent and hard-brittle materials, each of the conventional processing techniques mentioned above cannot meet the requirements of high precision and high quality. Hence, there is a need to solve the above deficiencies/issues.

### SUMMARY

The present invention provides a hybrid material processing method including steps of emitting a laser beam toward an intended-to-be-modified area intended on a workpiece by the laser to perform a property modification for the intended-to-be-modified area; applying an optical image positioning assisted equipment to perform a precise positioning for the modified area or a positioning marker on the workpiece, so as to align a machine tool to the modified area; and driving the machine tool to perform a processing for the modified area.

The present invention further provides a hybrid material processing system including steps of a laser configured to emit a laser beam toward an intended-to-be-modified area on a workpiece to perform a property modification for the intended-to-be-modified area; an optical image positioning assisted equipment configured to perform a precise positioning for the modified area or a positioning marker on the workpiece, so as to align a machine tool to the modified area; and a robotic arm or a machine tool configured to drive the laser or the machine tool to perform the property modification for the intended-to-be-modified are or the processing for the modified area respectively.

The above content described in the summary is intended to provide a simplified summary for the presently disclosed invention, so that readers are able to have an initial and basic understanding to the presently disclosed invention. The above content is not aimed to reveal or disclose a comprehensive and detailed description for the present invention, and is never intended to indicate essential elements in various embodiments in the present invention, or define the scope or coverage in the present invention.

### DESCRIPTION OF THE DRAWINGS

A more complete appreciation of the invention and many of the attendant advantages thereof are readily obtained as the same become better understood by reference to the following detailed description when considered in connection with the accompanying drawing, wherein:

FIG. 1 is a schematic diagram illustrating the step which performs a property modification by using a laser in accordance with the present invention;

FIG. 2 is a schematic diagram illustrating a robotic arm that is used for performing a property modification on a three-dimensional irregular curved surface in accordance with the present invention;

FIG. 3 is a schematic diagram illustrating a five-axis machine tool that is used for processing the modified areas on a workpiece in accordance with the present invention;

FIG. 4 is a schematic diagram of system architecture illustrating a hybrid material processing system in accordance with the present invention;

FIG. 5 is a schematic diagram of system architecture illustrating a single robotic arm that is utilized to integrally implement the hybrid material processing method and system according to the present invention;

FIG. 6 is a schematic diagram of system architecture illustrating a single machine tool that is utilized to integrally implement the hybrid material processing method and system according to the present invention;

FIG. 7 is a schematic diagram illustrating an actual application scenario in which the method and system proposed according to the present invention is applied in a drilling operation to drill through holes for a ceramic guide plate on a probe card device;

FIG. 8 is an actual image showing the property modified area that is modified from the intended-to-be-modified area by laser modification through implementing the hybrid material processing method according to the present invention;

FIG. 9 is an actual image showing the machined holes on the property modified areas where are mechanically drilled through by implementing the hybrid material processing method according to the present invention; and,

FIG. 10 is a flow chart illustrating the steps included in one embodiment for the hybrid material processing method according to the present invention.

### DETAILED DESCRIPTION

The present disclosure will be described with respect to particular embodiments and with reference to certain drawings, but the disclosure is not limited thereto but is only limited by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice.

It is to be noticed that the term “including,” used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device including means A and B” should not be limited to devices consisting only of components A and B.

The disclosure will now be described by a detailed description of several embodiments. It is clear that other embodiments can be configured according to the knowledge of persons skilled in the art without departing from the true technical teaching of the present disclosure, the claimed disclosure being limited only by the terms of the appended claims.

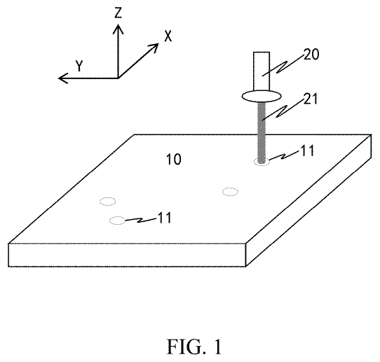

FIG. 1 is a schematic diagram illustrating the step which performs a property modification by using a laser in accordance with the present invention. In the present embodiment, the first step is to use a laser 20 to aim at intended-to-be-modified areas 11 on a workpiece 10, and then emitting a laser beam 21 toward the intended-to-be-modified areas 11, wherein the laser 20 could be a continuous laser or a pulsed laser, and the pulse duration could be of nanoseconds, picoseconds, or femtoseconds, etc. The intended-to-be-modified areas 11 can be also called targeted areas or working areas, etc.

The laser beam 21 is capable of being adjusted by a set of optical lens, so as to change its, for example but not limited to, spot sizes and laser beam shapes, etc. Preferably, the beam shapes could be, for example but not limited to, the Bessel beam, the Gaussian beam, or the top flat beam, etc. Alternatively, it can be other beam shapes applicable for property modification. Temporally, the frequencies and radiation pulse durations could be modulated. The amount of power depends on the material of the workpiece. The amount of power would only change the property of the material of the intended-to-be-modified area of the workpiece, without affecting the properties of the material of areas of the workpiece 10 other than the intended-to-be-modified areas 11.

With the combinations and modulations of different beam shapes, different working frequencies, and different pulse durations, the laser beam 21 could carry suitable energy. When the laser beam 21 reaches the intended-to-be-modified areas 11, the power density will, along with the sharp increase in energy, be sufficient to change the properties of the intended-to-be-modified areas 11, including physical or chemical properties, through physical mechanisms, such as, but not limited to, increasing temperature, or chemical mechanisms, such as, but not limited to, bonding changing. However, since the laser only interacts with the material in an extremely short time, most of the energy will be merely restricted within the regions of the intended-to-be-modified areas 11, and is unlikely to exceed to surrounding areas. Therefore, except for the intended-to-be-modified area 11, the materials of the surrounding areas should not be affected, and the properties thereof should not be changed, either.

After the property of the intended-to-be-modified areas 11 has been modified, the micro-structures of the material of the intended-to-be-modified areas 11 are re-constructed, producing new structures of property modification. The parts of the intended-to-be-modified areas 11 that have undergone property modification are softer than the original hard-brittle structures, which helps the subsequent processing. To modify the physical or chemical properties of the intended-to-be-modified areas 11 on different kinds of workpieces formed of different materials and having different physical and chemical properties, the laser 20 could be lasers of different types; alternatively, the process could optionally use laser beams of different working frequencies, wavelengths, pulse durations, and powers, or could modulate beams having different beam shapes.

During the process of modifying property by a laser, the workpiece 10 could be also optionally placed in an environment containing a working fluid the whole time, which would make it easier to remove processed debris, enhance the heating effect, or facilitate the processing speed. The working fluid could be gas or liquid. If it is gas, the gas could be selected from the group consisting of, for example but not limited to, neutral gas, inert gas, nitrogen, argon, acid vapor, alkali vapor, etc. If it is liquid, the liquid could be selected from the group consisting of, for example but not limited to, acid liquid, alkali liquid, neutral liquid, etching liquid, or a combination thereof. The etching liquid is selected from the group consisting of, for example but not limited to, sulfuric acid, phosphoric acid, potassium hydroxide, nitric acid, hydrofluoric acid, or a combination thereof. The alkali liquid is selected from the group consisting of, for example but not limited to, sodium hydroxide, potassium hydroxide, etc., or a combination thereof. The neutral liquid is selected from the group consisting of, for example but not limited to, deionized water, pure water, or a combination thereof. The volatile liquid is selected from the group consisting of, for example but not limited to, isopropyl alcohol, ethanol, or a combination thereof. The liquid could be oily liquid as well.

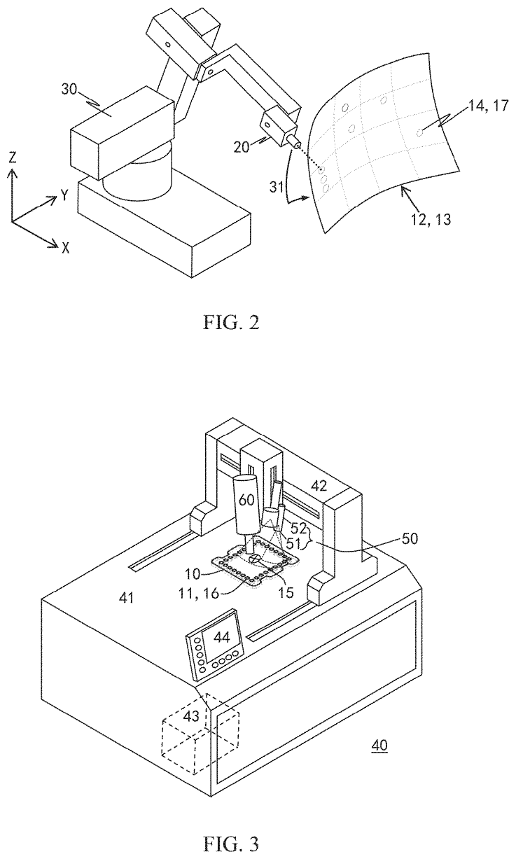

FIG. 2 is a schematic diagram illustrating a robotic arm that is used for performing a property modification on a three-dimensional irregular curved surface in accordance with the present invention. In the present embodiment, the laser 20 is combined with the robotic arm 30. With the assistance of the robotic arm 30, the process can be done along a predetermined working path, which includes a three-dimensional working path 31, whereby to effectively and rapidly perform the property modification with laser on multiple three-dimensional intended-to-be-modified areas 14 distributed on the three-dimensional workpiece 12. This is particularly suitable for performing surficial, partial, or internal property modification for multiple three-dimensional intended-to-be-modified areas 14 on a three-dimensional irregular curved surface 13 of three-dimensional workpieces 12 having complicated surface structures or three-dimensional structures. After the property modification, the three-dimensional intended-to-be-modified areas 14 have become three-dimensional modified areas 17. After the property modification, the machine tool on the robotic arm 30 can be used simultaneously to mechanically process the three-dimensional modified areas 17.

Preferably, the robotic arm 30 is selected from the group consisting of, for example but not limited to, FANUC robotic arms, KUKA robotic arms, FESTO robotic arms, ABB robotic arms, collaborative robots of Universal Robots, selective compliance articulated robot arms (SCARA), multi-axis industrial robotic arms, etc. The laser device mentioned above could be also installed at a machine tool to simultaneously perform a hybrid processing consisting of the property modification performed with laser and mechanical processing.

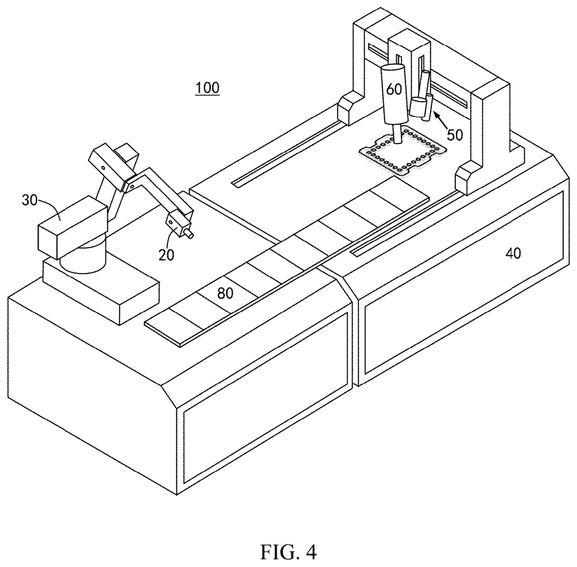

FIG. 3 is a schematic diagram illustrating a five-axis machine tool that is used for processing the modified areas on a workpiece in accordance with the present invention. When the property modification is done with the laser, the workpiece 10 should be transferred onto the machine tool 40 by using, for example but not limited to, the robotic arm 30 or other transporting devices, which include, for example but not limited to, conveyor belts, slide rails, etc., whereby the workpiece 10 could have hybrid processing performed thereto.

The machine tool 40 could be a multi-axis processing machine, a multi-axis engraving and milling machine, a lathe machine, a boring machine, a grinding machine, a polishing machine, a milling machine, or a drilling machine. In the present embodiment, machine tool 40 is preferable to be, for example but not limited to, a five-axis machine tool. Preferably, the configuration of the machine tool 40 includes a machine bed 41, a column moving gantry 42, a driver module 43, a controller module 44, an optical image positioning assisted equipment 50, a processing tool 60, etc., wherein the optical image positioning assisted equipment 50 includes a low magnification camera lens 51, and a high magnification camera lens 52 for precise positioning.

The scope of the intended-to-be-modified areas 11 which need to be processed on the workpiece 10 could be extremely tiny holes or grooves. Take drilling process as an example, through holes provided at the intended-to-be-modified areas 11 are preferable to have a diameter roughly smaller than 20 μm, which needs the assistance of the optical image positioning assisted equipment 50 to perform the precise positioning. After the property modification performed with laser, the intended-to-be-modified areas 11 have become modified areas 16.

The low magnification camera lens 51 which has a greater field of view (FOV) is used first to initial positioning, whereby to confirm the positions of the modified areas 16 on the workpiece 10 which already have their properties modified by laser, or confirm the positions of positioning markers 15 on the workpiece 10. After that, the high magnification camera lens 52 which has a smaller FOV is used for precise positioning. By aiming the processing tool 60 of the machine tool 40 at one of the modified areas 16 on the workpiece 10, a center of one of the modified areas 16, or one of the positioning markers 15, the detailed information regarding the positions for processing on the workpiece could be obtained. Through such multi-step positioning, the overall positioning precision could reach 1 μm. The “low magnification” mentioned above refers to magnifications proximately lower than 20 times (20×), and the “high magnification” mentioned above refers to magnifications proximately higher than 20 times (20×). The optical image positioning assisted equipment 50 could also be one single zoom optical device.

The image signals captured by the high magnification camera lens will be synchronously transmitted to the controller module 44 or an external computing device, wherein the external computing device includes, for example but not limited to, an industrial computer or a cloud computing device. An image processing algorithm could then be performed to filter or remove noises from the captured image containing the workpiece 10 to filter out the noises caused by any environmental disturbances in the image.

Preferably, the processing tool 60 is drill bits or machine tools of different forms, which is connected to, for example but not limited to, a high-speed spindle, a milling spindle, a turning spindle, a boring and milling spindle, a high-speed built-in spindle, drilling spindle, a tapping spindle, an ultrasound spindle, or an engraving spindle to perform various kinds of processing, which include, for example but not limited to, drilling, cutting, milling, engraving, carving, surface grinding and polishing, or a combination thereof.

While the processing tool 60 is performing the machining, the processing tool 60 will operate at high speed. By increasing the overall stiffness of the machine tool for the processing process, the machine tool would not break while processing hard-brittle objects. In the aspect of commands of processing, take drilling as an example, it is preferable to use, for example but not limited to, the FANUC G83 command setting for deep hole reciprocating chip removal. By setting up the depth of each feeding, the feeding speed, and the reference regress coordinates, excellent processing quality could be obtained.

While the processing tool 60 is performing the processing, the workpiece 10 could be also optionally placed in an environment containing a working fluid the whole time, which would make it easier for chip removal, enhance the heating effect, or facilitate the processing speed. The working fluid could be gas or liquid. If it is gas, the gas could be selected from the group consisting of, for example but not limited to, neutral gas, inert gas, nitrogen, argon, acid vapor, alkali vapor, etc. If it is liquid, the liquid could be selected from the group consisting of, for example but not limited to, acid liquid, alkali liquid, neutral liquid, etching liquid, or a combination thereof. The etching liquid is selected from the group consisting of, for example but not limited to, sulfuric acid, phosphoric acid, potassium hydroxide, nitric acid, hydrofluoric acid, or a combination thereof. The alkali liquid is selected from the group consisting of, for example but not limited to, sodium hydroxide, potassium hydroxide, etc., or a combination thereof. The neutral liquid is selected from the group consisting of, for example but not limited to, deionized water, pure water, or a combination thereof. The volatile liquid is selected from the group consisting of, for example but not limited to, isopropyl alcohol, ethanol, or a combination thereof. The liquid could be oily liquid as well.

In another embodiment, to increase processing efficiency, a cutting surface of the processing tool 60 could be coated with a layer of novel metal, for example but not limited to platinum, gold, or silver. While processing in acid or alkali liquids, a catalytic mechanism could be used to facilitate the processing and reduce processing time. If the liquid used is neutral liquid, another set of electrodes could be added, with one electrode connected to the workpiece, and the other soaked into the liquid.

FIG. 4 is a schematic diagram of system architecture illustrating a hybrid material processing system in accordance with the present invention. The present invention provides a hybrid material processing system 100 which, preferably, could be used to perform a hybrid material processing method. The system 100 includes the laser 20, the machine tool 40, the optical image positioning assisted equipment 50, the processing tool 60, etc., and further includes a robotic arm 30 or other transporting means such as a conveyor belt 80, slide rails, etc.

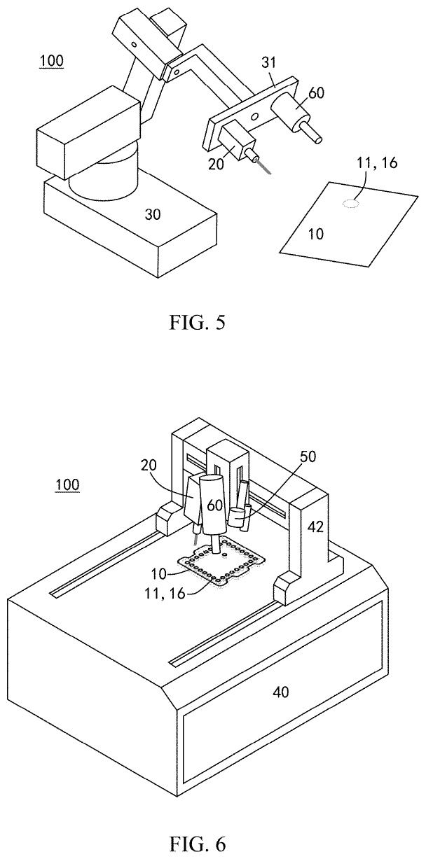

FIG. 5 is a schematic diagram of system architecture illustrating a single robotic arm that is utilized to integrally implement the hybrid material processing method and system according to the present invention. In the present embodiment, the hybrid material processing system 100 of the present invention is implemented by being integrated into a single robotic arm, wherein the laser 20 and the processing tool 60 are provided on an end effector 31 of the robotic arm 30. The robotic arm 30 could respectively drive the laser 20 and the processing tool 60 to perform the property modification and processing to the intended-to-be-modified areas 11 and the modified areas 16 of the workpiece 10.

FIG. 6 is a schematic diagram of system architecture illustrating a single machine tool that is utilized to integrally implement the hybrid material processing method and system according to the present invention. In the present embodiment, the hybrid material processing system 100 of the present invention is implemented by being integrated into a single machine tool, wherein the laser 20 is installed at the machine tool 40, and the laser 20 has a motion relative to the workpiece 10 due to the driving of the column moving gantry 42, whereby to perform the property modification to the intended-to-be-modified areas 11 contained by the workpiece 10. When the property modification is done, the processing tool 60 will be precisely positioned through the optical image positioning assisted equipment 50, and then processing the modified areas 16.

In some embodiments, the hybrid material processing system 100 of the present invention is integrated into a single work station, a work cell, a same device, or a same production line, whereby to integrally perform the property modification, which is done through laser, and the mechanical processing. However, in some embodiments, the hybrid material processing system 100 of the present invention is separated and placed in two work stations, which are located at two different locations and are respectively used for performing the property modification, which is done through laser, and the mechanical processing.

In another embodiment, the hybrid material processing system 100 of the present invention is, preferably, integrated into a single work station, wherein the configuration of work cells of this single work station at least includes the laser 20, the robotic arm 30, etc., whereby to perform the property modification with laser, and at least further includes the machine tool 40, the optical image positioning assisted equipment 50, the processing tool 60, etc., whereby to perform the mechanic processing.

In another embodiment, the hybrid material processing system 100 of the present invention is, preferably, implemented as distributed in several different work stations respectively. For example, but not limited to, the hybrid material processing system 100 could be distributed in a first work station and a second work station, respectively. The configuration of work cells of the first work station at least includes the laser 20, the robotic arm 30, etc., whereby perform the property modification with laser, while the configuration of work cells of the second work station at least includes the machine tool 40, the optical image positioning assisted equipment 50, the processing tool 60, etc., whereby to perform the mechanic processing. When the workpiece 10 is going to be transferred from the first work station to the second work station, the transformation could be done by the robotic arm 30, or there could be other transmitting means, such as conveyors, conveyor belts, and linear slide rails, deployed between the first work station and the second work station, whereby to transfer the workpiece 10 from the first work station to the second work station.

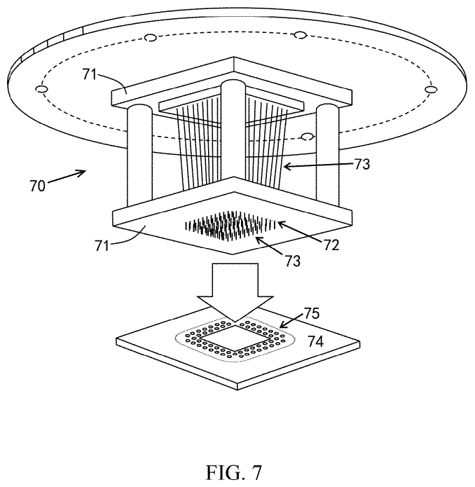

FIG. 7 is a schematic diagram illustrating an actual application scenario in which the method and system proposed according to the present invention is applied in a drilling operation to drill through holes for a ceramic probe card. Probe cards provide electrical connection between dies and testers for the characterizations of integrated circuits (ICs) before encapsulation. Therefore, probe cards can be deemed a kind of special connector for dealing with the hugely increased density of bond pads in a unit area, which is a consequence of miniaturizing ICs. Take a vertical probe card as an example. A ceramic guide plate 71 of a probe card 70 is served as a probe jig, and has the properties of low inductance, low thermal expansion, low impedance, and high strength. The ceramic guide plate 71 has to be provided with a lot of, maybe hundreds, probe holes 72 very precisely and intensively with a tiny area thereon, so that probe pins 73 could be intensively arranged. In this way, the probe pins 73 could electrically contact the bond pads 75 on the dice 74. Preferably, the diameters of these probe holes 73 are less than 20 μm, which would allow probe pins with fewer diameters to be arranged, and the number density of the probe pins within a unit area could be increased.

Conventional processing techniques mostly replace drill bits with thinner ones to drill smaller holes. However, when drilling through holes of high density within a unit area on an ultrahard ceramic material, the drill bits may break due to insufficient mechanical strength, and the spaces between holes may crack for not being able to withstand the stress induced at the duration of drilling. In addition, the processed holes may be also damaged. In contrast, the hybrid material processing method of the present invention could be applied to drilling probe cards, which would enhance the overall processing quality of the drilling.

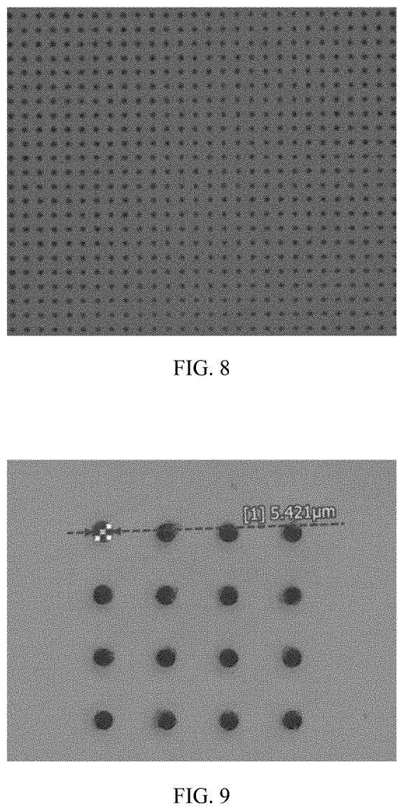

FIG. 8 is an actual image showing the property modified area that is modified from the intended-to-be-modified area by laser modification by implementing the hybrid material processing method according to the present invention. FIG. 9 is an actual image showing the machined holes on the property modified areas where are mechanically drilled through by implementing the hybrid material processing method according to the present invention. The hybrid material processing method proposed in the present invention is preferable to be applied to process hard-brittle materials, superhard or ultrahard materials, difficult-to-cut materials, articles having three-dimensional structures, or articles having three-dimensional structures containing three-dimensional curved surfaces. First, by using laser beams that carry appropriate energy, the properties of the material would be modified. After the precise optical positioning, the mechanical processing would be performed. The method and system proposed in the present invention could provide higher efficiency than all kinds of conventional processing techniques. With its properties modified, the material would not have taper hole angles created while being drilled by the machine tool, and the inner periphery of each hole could reach the level of mirror surface roughness. Furthermore, the method and system provided in the present invention also have other advantages, such as less wear and a longer lifespan for the machine tool, etc.

The hybrid material processing method proposed in the present invention is at least applicable for objects made of, but not limited to, one of the following materials, and the objects are used as the workpiece 10: Si, AlN, Ga₂O₃, GaN, sapphire, glass, CdS, SiC, Si₃N₄, Al₂O₃, ZrO₂, superalloy, quartz, ceramics, Ti₆Al₄V, metallic glass, diamond, polycrystalline diamond, TiN, VN, WC, titanium alloy, STAVAX, and inconel.

In summary, the present invention uses a hybrid processing method to process hard-brittle materials. First, modify the properties of the material through laser energy, and then perform secondary processing through, for example, but not limited to, a high-speed engraving and milling machine. Drilling with an engraving and milling machine would not create taper hole angles, and the inner periphery of the holes could reach the level of mirror surface roughness. In addition, the wear of the machine tool could be effectively improved, and the lifespan of the machine tool could be increased.

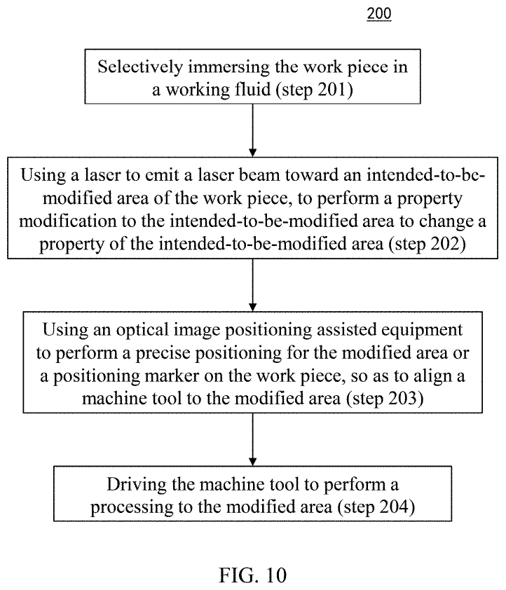

FIG. 10 is a flow chart illustrating the steps included in one embodiment for the hybrid material processing method according to the present invention. In the present embodiment, the hybrid material processing method 200 of the present invention is preferable to have the following steps: selectively immersing the workpiece in a working fluid (Step 201); using a laser to emit a laser beam toward an intended-to-be-modified area of the workpiece, to perform a property modification to the intended-to-be-modified area to change a property of the intended-to-be-modified area (Step 202); using an optical image positioning assisted equipment to perform a precise positioning for the modified area or a positioning marker on the workpiece, so as to align a machine tool to the modified area (Step 203); and driving the machine tool to perform processing to the modified area (Step 204).

The present invention proposes to use a hybrid processing method to process materials. First, modify the properties of materials through laser energy, and then perform processing through a high-speed machine tool. For the processing of extremely precise hole arrays, the diameter of the holes often needs to be less than 20 μm. Therefore, each hole region corresponding to a modified area processed with laser is extremely small. In light of this, before performing the subsequent mechanical drilling, it needs to use an optical precise positioning technique, which uses a low magnification camera to perform an initial positioning of a large area and a large field of view (FOV), and then uses a high magnification camera to perform a precise positioning of a small area and a small field of view (FOV). The overall position precision could achieve less than 1 μm. A zoom camera could be also used for the positioning of large and small areas.

In comparison to conventional processing techniques, the method proposed in the present invention could provide higher efficiency. Take drilling as an example; the method could be used to produce through holes or blind vias with diameters less than 20 μm. The produced through holes and blind vias would not have the problem of taper hole angles, and the inner periphery of the holes and vias could reach the level of mirror surface roughness. The method could also effectively improve the wear of the machine tool, and increase the lifespan of the machine tool.

The present invention proposes a hybrid material processing method, which includes the steps of: using a laser to emit a laser beam toward an intended-to-be-modified area of a workpiece, whereby to perform a property modification to the intended-to-be-modified area with a laser to change a material property of the intended-to-be-modified area; using an optical positioning technique to perform a multi-step positioning, whereby to align the machine tool to the modified area; and driving the machine tool to perform processing to the modified area. The laser device could be one or multiple laser sources, and the laser sources could be point light sources or line light sources. There could be more than one point light sources or more than one line light sources to perform the property modification to the workpiece simultaneously. The laser source could be a continuous or pulsed laser. The continuous laser could be a CO₂ laser, a CO laser, a helium cadmium laser, a semiconductor laser, an optical fiber laser, or a He—Ne laser. The pulsed laser could be an excimer laser, an optical fiber laser, or an Nd:YAG laser. The wavelength of the laser beam could be that of EUV, DUV, UV, green light, near-infrared light, mid-infrared light, etc.

The hybrid material processing method mentioned above further includes steps among the following steps: transfer the workpiece processed by the laser beam to a machine tool containing the processing tool; use the optical image positioning assisted equipment with low magnification to perform positioning of a large area and a large field of view to multiple position marks on the surface of the workpiece, and convert the position marking image coordinate system into a mechanical processing coordinate system; according to the mechanical processing coordinate system, use the optical image positioning assisted equipment with high magnification to aim at the position marks for extremely precise positioning; convert the precise position marking image coordinate system into another mechanical processing coordinate system. If the processed holes are larger and therefore the precision for positioning has a lower accuracy requirement, it would only need the optical image positioning assisted equipment with low magnification to perform the positioning. The camera device mentioned above could also use one single zoom optical device for performing positioning of large and small areas. Use the optical image positioning device to perform the precise positioning, whereby to align the machine tool to the intended-to-be-modified area for processing. Preferably, the workpiece for the above-mentioned property modification done by laser and mechanical processing needs to be soaked into a liquid, wherein the liquid could be acid, neutral, alkali, or volatile liquid. The acid liquid could be sulfuric acid, phosphoric acid, potassium hydroxide, nitric acid, hydrofluoric acid, or a combination thereof. The alkali liquid could be sodium hydroxide, potassium hydroxide, etc., or a combination thereof. The neutral liquid could be deionized water or pure water. The volatile liquid could be isopropyl alcohol, ethanol, or a combination thereof. The liquid could be also oily liquid. The material of the workpiece could be Si, SiC, AlN, Ga₂O₃, sapphire, CdS, GaN, glass, quartz, or polycrystalline diamond (PCD).

The laser device and the machining tool mentioned above both could be implemented on the machine tool or the robotic arm. Using the robotic arm to perform the hybrid material processing method mentioned above further includes steps among the following steps: use the robotic arm to move the laser to perform the property modification to the intended-to-be-modified area of the workpiece; the robotic arm could move the laser along the three-dimensional working path to perform the property modification to a three-dimensional curved surface of the workpiece; and use the robotic arm to move the workpiece processed by the laser beam to perform the property modification of the modified area of the workpiece, wherein the modified area could be a through hole, a blind via, a groove which are intended to be formed inside the workpiece, or a of an arbitrary shape on a surface of the workpiece, or an area on the surface of the workpiece which needs to reduce its roughness. The machine tool could be a hole processing tool, a surface engraving, and milling tool, or a surface polishing tool, or a combination thereof. The processing steps mentioned above could be done at the machine tool.

The present invention is a hybrid material processing method, which includes: using a laser to emit a laser beam toward an intended-to-be-modified area of a workpiece, whereby to perform a property modification to the intended-to-be-modified area to modify a property of the intended-to-be-modified area; using an optical image positioning assisted equipment to perform a precise positioning for the modified area or a positioning marker on the workpiece; and driving a machine tool to perform a processing to the modified area. The workpiece for the property modification with laser and the processing with the machine tool could be soaked in a working fluid. The working fluid could be gas or liquid. The gas is selected from a group consisting of nitrogen, argon, acid vapor, alkali vapor, or a combination thereof. The liquid is selected from a group consisting of acid liquid, alkali liquid, neutral liquid, etching liquid, neutral gas, inert gas, or a combination thereof. The acid liquid could be sulfuric acid, phosphoric acid, potassium hydroxide, nitric acid, hydrofluoric acid, or a combination thereof. The alkali liquid could be sodium hydroxide, potassium hydroxide, etc., or a combination thereof. The neutral liquid could be deionized water or pure water. The volatile liquid could be isopropyl alcohol, ethanol, or a combination thereof, or a combination thereof. The liquid could also be oily liquid. Use a robotic arm to move the laser to perform the property modification to the intended-to-be-modified area of the workpiece. Use the robotic arm to move the machine tool to perform the processing to the modified area of the workpiece. The robotic arm moves the laser along a three-dimensional working path, whereby to perform the property modification to a three-dimensional curved surface contained in the intended-to-be-modified area of the workpiece. The laser is installed in a machine tool, so that the laser and the workpiece could have a relative motion, whereby the laser could perform the property modification to the intended-to-be-modified area of the workpiece. Use the machine tool to make the machine tool and the workpiece have the relative motion, so that the machine tool could perform the processing to the modified area of the workpiece. The machine tool could be a multi-axis processing machine, a multi-axis engraving and milling machine, a lathe machine, a boring machine, a grinding machine, a polishing machine, a milling machine, or a drilling machine. The laser could be a continuous laser, a pulsed laser, or a combination thereof. The workpiece is a hard-brittle material, a superhard or ultrahard material, a difficult-to-cut material, an article having a three-dimensional structure, or an article having a three-dimensional structure containing a three-dimensional curved surface.

The present invention is a hybrid material processing system, which includes a laser configured to emit a laser beam toward an intended-to-be-modified area of a workpiece, whereby to perform a property modification to the intended-to-be-modified area; an optical image positioning assisted equipment configured to perform a precise positioning for a modified area or a positioning marker of the workpiece; and a robotic arm or a machine tool configured to drive the laser and the machine tool to respectively perform the property modification and a processing to the intended-to-be-modified area and the modified area of the workpiece. The robotic arm is configured to move the laser along a three-dimensional working path, whereby to perform the property modification to a three-dimensional curved surface contained in the intended-to-be-modified area of the workpiece.

There are further embodiments provided as follows.

Embodiment 1: a hybrid material processing method includes steps of: emitting a laser beam toward an intended-to-be-modified area intended on a workpiece by a laser to perform a property modification for the intended-to-be-modified area; applying an optical image positioning assisted equipment to perform a precise positioning for a modified area or a positioning marker on the workpiece, so as to align a machine tool to the modified area; and driving the machine tool to perform a processing for the modified area.

Embodiment 2: the hybrid material processing method as described in embodiment 1 further includes steps of: immersing the workpiece in a working fluid; performing a relative motion of the machine tool with respect to the workpiece by using a machine tool, to drive the machine tool to perform a processing for the modified area; performing a property modification for the intended-to-be-modified area by the laser which is moved and carried by a robotic arm; and perform a processing for the modified area by the machine tool which is moved and carried by the robotic arm.

Embodiment 3: the hybrid material processing method as described in embodiment 2, the working fluid is a gas or a liquid.

Embodiment 4: the hybrid material processing method as described in embodiment 3, the gas is selected from one of a neutral gas, an inert gas, a nitrogen, an argon, an acid vapor, an alkali vapor, and a combination thereof, the liquid is selected from one of an oily liquid, an acid liquid, an alkali liquid, a neutral liquid, an etching liquid, a volatile liquid, and a combination thereof, the acid liquid is selected from a sulfuric acid, a phosphoric acid, a potassium hydroxide, a nitric acid, a hydrofluoric acid, and a combination thereof, the alkali liquid is selected from a sodium hydroxide, potassium hydroxide, and a combination thereof, the neutral liquid is selected from an deionized water, a pure water, and a combination thereof, and the volatile liquid is selected from an isopropyl alcohol, an ethanol, and a combination thereof.

Embodiment 5: the hybrid material processing method as described in embodiment 3, the robotic arm is configured to move the laser in compliance with a three-dimensional working path, to perform the property modification for a three-dimensional curved surface included in the intended-to-be-modified area on the workpiece.

Embodiment 6: the hybrid material processing method as described in embodiment 2, the machine tool is selected from a multi-axis processing machine, a multi-axis engraving and milling machine, a lathe machine, a boring machine, a grinding machine, a polishing machine, a mechanical press, a milling machine or a drilling machine.

Embodiment 7: the hybrid material processing method as described in embodiment 2, the laser is selected from one of a continuous laser, a pulsed laser, or a combination thereof.

Embodiment 8: the hybrid material processing method as described in embodiment 2, the workpiece is a hard-brittle material, a superhard material, an ultrahard material, a difficult-to-cut material, an article having a three-dimensional structure, a three-dimensional structure article including a three-dimensional curved surface.

Embodiment 9: the hybrid material processing method as described in embodiment 1, the machine tool has a cutting surface which is coated with a layer of noble metal.

Embodiment 10: a hybrid material processing system includes: a laser configured to emit a laser beam toward an intended-to-be-modified area on a workpiece to perform a property modification for the intended-to-be-modified area; an optical image positioning assisted equipment configured to perform a precise positioning for a modified area or a positioning marker on the workpiece, so as to align a machine tool to the modified area; and a robotic arm or a machine tool configured to drive the laser or the machine tool to perform the property modification for the intended-to-be-modified are or the processing for the modified area respectively.

Embodiment 11: the hybrid material processing system as described in embodiment 10, the robotic arm is configured to move the laser in compliance with a three-dimensional working path, to perform the property modification for a three-dimensional curved surface included in the intended-to-be-modified area on the workpiece.

Embodiment 12: the hybrid material processing system as described in embodiment 10, the laser is disposed on the machine tool and configured to perform a relative motion with respect to the workpiece, to drive the laser to perform the property modification for the intended-to-be-modified area on the workpiece.

Embodiment 13: the hybrid material processing system as described in embodiment 10, the machine tool has a cutting surface which is coated with a layer of noble metal.

While the disclosure has been described in terms of what are presently considered to be the most practical and preferred embodiments, it is to be understood that the disclosure need not be limited to the disclosed embodiments. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present disclosure which is defined by the appended claims.

What is claimed is:

1. A hybrid material processing method, comprising:
emitting a laser beam toward an intended-to-be-modified area intended on a workpiece by a laser to perform a property modification for the intended-to-be-modified area;
applying an optical image positioning assisted equipment to perform a precise positioning for a modified area or a positioning marker on the workpiece, so as to align a machine tool to the modified area; and
driving the machine tool to perform a processing for the modified area.

2. The hybrid material processing method as claimed in claim 1, further comprising:
immersing the workpiece in a working fluid;
performing a relative motion of the machine tool with respect to the workpiece by using a machine tool, to drive the machine tool to perform a processing for the modified area;
performing a property modification for the intended-to-be-modified area by the laser which is moved and carried by a robotic arm; and
perform a processing for the modified area by the machine tool which is moved and carried by the robotic arm.

3. The hybrid material processing method as claimed in claim 2, wherein the working fluid is a gas or a liquid.

4. The hybrid material processing method as claimed in claim 3, wherein the gas is selected from one of a neutral gas, an inert gas, a nitrogen, an argon, an acid vapor, an alkali vapor, and a combination thereof, the liquid is selected from one of an oily liquid, an acid liquid, an alkali liquid, a neutral liquid, an etching liquid, a volatile liquid, and a combination thereof, the acid liquid is selected from a sulfuric acid, a phosphoric acid, a potassium hydroxide, a nitric acid, a hydrofluoric acid, and a combination thereof, the alkali liquid is selected from a sodium hydroxide, potassium hydroxide, and a combination thereof, the neutral liquid is selected from an deionized water, a pure water, and a combination thereof, and the volatile liquid is selected from an isopropyl alcohol, an ethanol, and a combination thereof.

5. The hybrid material processing method as claimed in claim 3, wherein the robotic arm is configured to move the laser in compliance with a three-dimensional working path, to perform the property modification for a three-dimensional curved surface included in the intended-to-be-modified area on the workpiece.

6. The hybrid material processing method as claimed in claim 2, wherein the machine tool is selected from a multi-axis processing machine, a multi-axis engraving and milling machine, a lathe machine, a boring machine, a grinding machine, a polishing machine, a punching machine, a press maching, a stamping machine, a milling machine or a drilling machine.

7. The hybrid material processing method as claimed in claim 2, wherein the laser is selected from one of a continuous laser, a pulsed laser, or a combination thereof.

8. The hybrid material processing method as claimed in claim 2, wherein the workpiece is a hard-brittle material, a superhard material, an ultrahard material, a difficult-to-cut material, an article having three-dimensional structure, or a three-dimensional structure article including a three-dimensional curved surface.

9. The hybrid material processing method as claimed in claim 1, wherein the machine tool has a cutting surface which is coated with a layer of noble metal.

10. A hybrid material processing system, comprising:
a laser configured to emit a laser beam toward an intended-to-be-modified area on a workpiece to perform a property modification for the intended-to-be-modified area;
an optical image positioning assisted equipment configured to perform a precise positioning for a modified area or a positioning marker on the workpiece, so as to align a machine tool to the modified area; and
a robotic arm or a machine tool configured to drive the laser or the machine tool to perform the property modification for the intended-to-be-modified area or the processing for the modified area respectively.

11. The hybrid material processing system as claimed in claim 10, wherein the robotic arm is configured to move the laser in compliance with a three-dimensional working path, to perform the property modification for a three-dimensional curved surface included in the intended-to-be-modified area on the workpiece.

12. The hybrid material processing system as claimed in claim 10, wherein the laser is disposed on the machine tool and configured to perform a relative motion with respect to the workpiece, to drive the laser to perform the property modification for the intended-to-be-modified area on the workpiece.

13. The hybrid material processing system as claimed in claim 10, wherein the machine tool has a cutting surface which is coated with a layer of noble metal.
